(19) United States
(12) Patent Application Publication
(10) Pub. No.: US 2004/0017786 A1
(43) Pub. Date: Jan. 29, 2004

(54) System and method for providing dual mode communication to a wireless device

(76) Inventor: David Grant Shively, Smyrna, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/202,441

(22) Filed: Jul. 24, 2002

(51) Int. Cl. H04Q 7/00

(52) U.S. Cl. 370/328; 370/338; 370/460

(57) ABSTRACT

An access point for interfacing a mobile station having a wireless local area network interface to a wireless telecommunications network. The access point comprises a wireless local area network interface, a processor, and a mobile telephony interface. The wireless local area network interface is operable to receive a packetized data stream from the interface of the mobile station. The processor transfers the packetized data stream to a first mobile telephony interface, wherein the first mobile telephony interface receives the packetized data stream and interfaces with a core network element to establish a communications link and transmit the packetized data stream to the core network element, such that the mobile station appears as an element in the mobile telephony network

### DESCRIPTION

1. Technical Field

This invention relates to the field of wireless communications, and more particularly, to a system and method for providing dual mode communications to a wireless device.

2. Background

Wireless devices are proliferating at a staggering rate across the world. One of the latest growth areas in wireless communications is wireless local area networks. Due to the high costs of retrofitting existing buildings and the flexibility afforded by being untethered, many consumers and business are realizing the advantages of wireless networking. However, those advantages are often not fully realized do to the balkanization of wireless standards and the incompatibility between wireless networking systems.

For instance, wireless local area networking technologies are not compatible with the newly arising 2.5 G and 3 G telecommunications networks that are being built out across the world. A user accessing a GSM/GPRS (Global System for Mobile Communications/General Packet Radio Service) network uses addressing and routing schemes that are unique to GSM systems. Similarly, wireless local networking schemes utilize 802.11, HomeRF, or Bluetooth technology, for example, that is not compatible with GSM systems. This incompatibility is particularly unfortunate because wireless local area network (WLAN) technology tends to operate at much higher bit rates than 2.5 G or 3G telecommunications networks.

It would be advantageous to have a system whereby a mobile station, such as a laptop, personal digital assistant, or mobile telephone, would be able to access wireless telephony infrastructure utilizing WLAN technology in addition to the standard telephony air interface technology. It is desirable to provide a mobile station the ability to communicate over a wireless telephone communications network's air interface, such as a GSM/GPRS network, when outside the range of a WLAN access point, but also be able to switch to the higher speed WLAN air interface when within range of a WLAN access point.

Exemplary embodiments of the present invention are directed at overcoming one or more of the problems inherent in the prior art.

### SUMMARY OF THE INVENTION

An access point for interfacing a mobile station having a wireless local area network interface to a wireless telecommunications network is disclosed. The access point comprises a wireless local area network interface, a processor, and a mobile telephony interface. The wireless local area network interface is operable to receive a packetized data stream from the interface of the mobile station. The processor transfers the packetized data stream to a first mobile telephony interface, wherein the first mobile telephony interface receives the packetized data stream and interfaces with a core network element to establish a communications link and transmit the packetized data stream to the core network element, such that the mobile station appears as an element in the mobile telephony network

Further, a method of establishing communication between a mobile station equipped with a wireless local area network interface and a mobile telephony network is disclosed. The method comprises establishing a wireless local area network connection with the mobile station; receiving a packetized data stream from the mobile station; converting the packetized data stream from a wireless local area network protocol to a mobile telephony protocol; and establishing a connection to the core network of the mobile telephony network and transferring the converted packetized data stream to the core network.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 illustrates a wireless telecommunications system in accordance with the principles of the present invention.

FIG. 2 illustrates one embodiment of an access point 160 that appears as a BTS according to the principles of the present invention.

FIG. 3 illustrates one embodiment of an access point 160 that appears as an SGSN according to the principles of the present invention.

FIG. 4 illustrates one embodiment of an access point 160 according to the principles of the present invention.

FIG. 5 illustrates a flow chart of the operation of the access point 160 according to the principles of the present invention.

### DETAILED DESCRIPTION

Reference will now be made to various embodiments according to this invention, examples of which are shown in the accompanying drawings and will be obvious from the description of the invention. In the drawings, the same reference numbers represent the same or similar elements in the different drawings whenever possible.

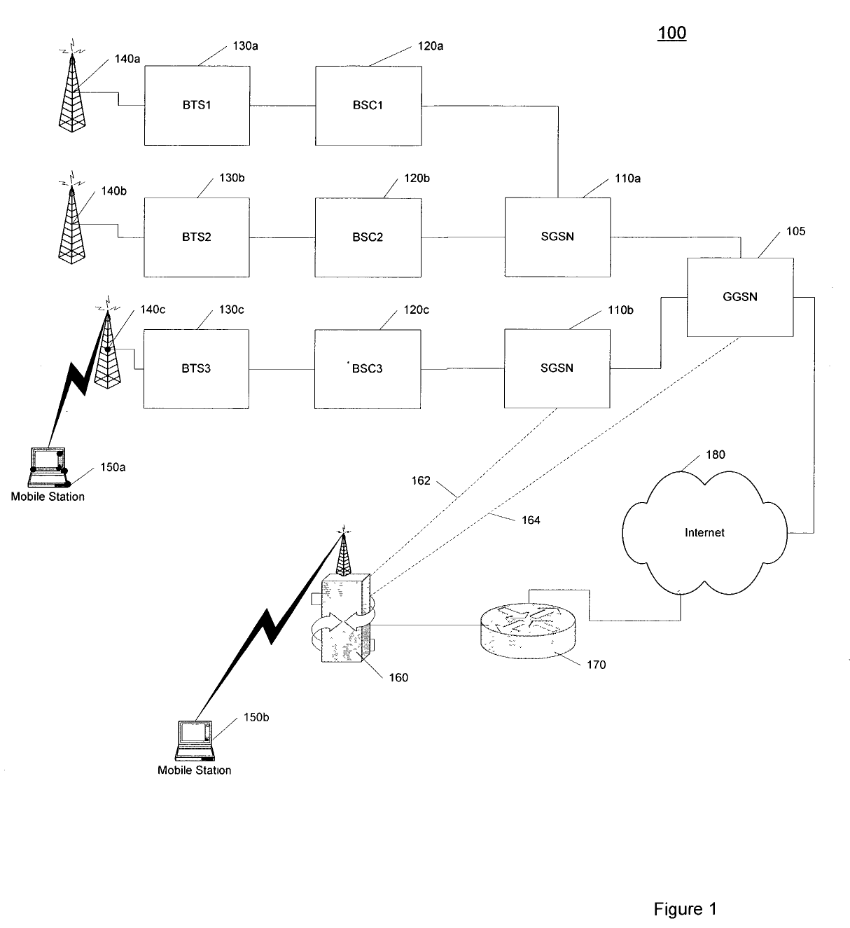

FIG. 1 illustrates a wireless telecommunications system in accordance with the principles of the present invention. A GSM/GPRS system is illustrated in this figure for exemplary purposes alone. Those skilled in the art will appreciate that other wireless telephony standards that utilize packet based communications may also be utilized to implement the present invention. For example, the present invention may be implemented within a CDMA 2000 or UMTS standard, in addition to the illustrated GSM/GPRS system. Mobile stations 150 comprise two telecommunications interfaces: a first interface comprises a mobile telephony interface, such as a GSM interface; and a second interface comprises a WLAN interface, such as 802.11b. Those skilled in the art will appreciate that other mobile telephony interfaces could be utilized, as well as other-WLAN interfaces. Through these interfaces, the mobile station 150 can communicate with either the GSM/GPRS network and/or the interface in two ways: through the mobile telephony air interface via antennae 140 or through an access point 160.

To assist in illustrating the operation of the present invention, discussion will begin with the standard GSM/GPRS interface well known to those skilled in the art. The mobile station 150a, for example, interfaces via an antenna, typically a radio tower 140, to a Base Transceiver Station (BTS) 130. The BTS 130 communicates to a Base Station Controller (BSC) 120. Each BSC 120 is typically paired to a respective BTS 130. One or more of the BSC 120 are coupled to a Serving GPRS Support Node (SGSN) 110 that handles packet data communication to the mobile station 150a. The SGSN provides packet routing, including mobility management, authentication and ciphering, to and from the GPRS subscriber on mobile station 150a. The SGSN 110 communicates with the Gateway GPRS Support Node (GGSN) 105 to interface to the Internet 180. The GGSN provides the gateway to the external network, handles security and accounting functions, and allocates IP addresses to the mobile station 150a. The GGSN 105 and SGSN 110 comprise the packet data nodes of the GSM/GPRS core network. In this way packetized data, i.e. Internet traffic, is transferred between the mobile station 150a and the Internet 180 over a standard GSM/GPRS interface.

A mobile station 150b may be within range of a WLAN access point 160 and communicate with the WLAN access point 160 utilizing the appropriate air interface standards, e.g., 802.11b or Bluetooth.

Exemplary embodiments of the present invention comprise the access point 160 which may communicate with the GSM/GPRS core network in one of three ways. First, the access point 160 may be configured with a data link 162 to an SGSN, for example SGSN 110b, to communicate data between the mobile station 150b and the SGSN 110b. In this way, the access point 160 may function as an element of the radio access network in a UMTS network or could take the place of a BSC in a GSM/GPRS network. This communication may utilize GSM/UMTS protocols, for example.

Second, the access point 160 may be configured with a data link 164 to the GGSN 105 to communicate data between the mobile station 150b and the GGSN 105. In this exemplary embodiment, the access point 160 functions as an SGSN and may communicate using GSM/UMTS protocols, for example. The access point 160 may include WLAN radio base station functionality and also contain sufficient network protocol functionality to operate as an SGSN, as well as an Ethernet node and/or an IP router.

Third, the access point 160 may be configured with a data link to a router 170 which utilizes Internet Protocol to tunnel via the Internet to the GGSN 105. In this method, the access point 160 functions as a “stand-alone” IP-based network node using IP-based protocols to communicate with the GGSN. The access point 160 may include WLAN radio base station functionality and also contain sufficient network protocol functionality to operate as an SGSN, as well as an Ethernet node and/or an IP router.

One to three of these alternative interfaces may be present in the access point 160. If multiple core network interfaces are present, the access point may make a decision as to which link to utilize to access the core network. By accessing the core network via the access point, the mobile station 150b may appear to the core network as if were connected to a BTS 130.

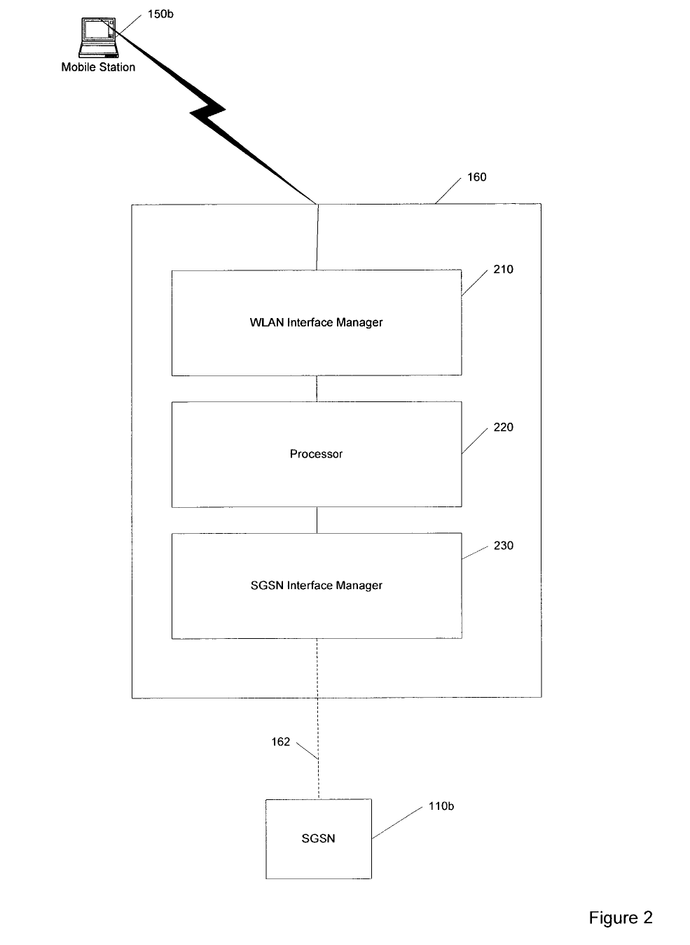

FIG. 2 illustrates one embodiment of an access point 160 that appears as a BTS according to the principles of the present invention. The access point 160 may comprise a WLAN interface manager and interface 210, a processor with accompanying memory 220, and an SGSN Interface Manager with interface 230. The WLAN Interface Manager 210 operates the protocols necessary to communicate with the proper WLAN standard to the mobile station 150b. This standard can be any WLAN standard, for example, 802.11b, 802.11a, HomeRF, or Bluetooth. The processor 220 interfaces the WLAN Interface Manger 210 to the SGSN Interface Manager 230. The SGSN Interface Manager 230 runs whatever protocols are necessary to appear to the SGSN 110b as a BSC. In an exemplary embodiment of the present invention, the SGSN Interface Manger 230 does all protocol conversion from the WLAN Interface Manager. In an alternative embodiment of the present invention, the Processor 220 handles the protocol conversion.

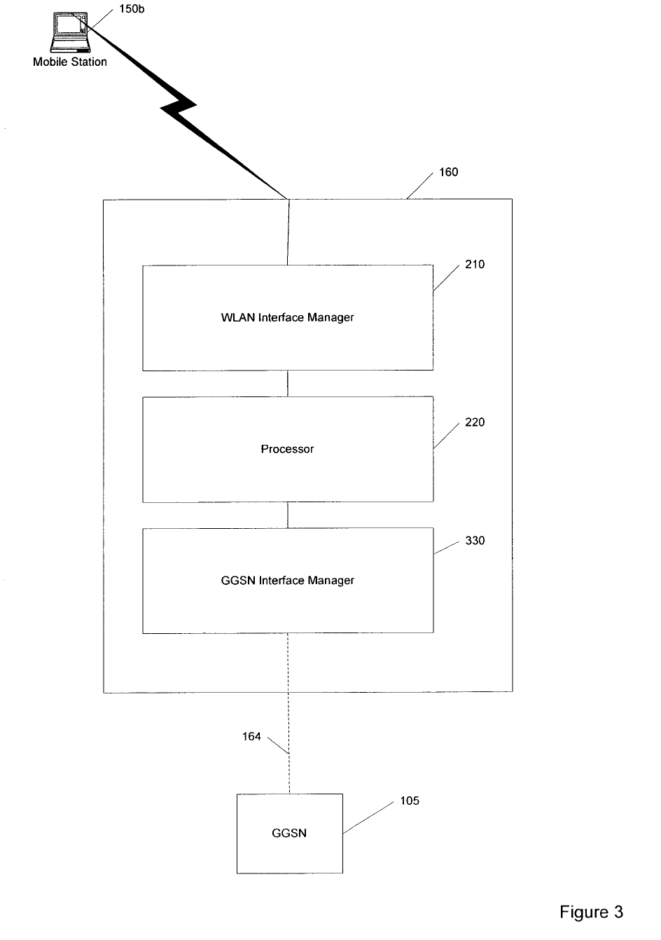

FIG. 3 illustrates one embodiment of an access point 160 that appears as an SGSN according to the principles of the present invention. The access point 160 may comprise a WLAN interface manager and interface 210, a processor with accompanying memory 220, and an GGSN Interface Manager with interface 330. The WLAN Interface Manager 210 operates the protocols necessary to communicate with the proper WLAN standard to the mobile station 150b. This standard can be any WLAN standard, for example, 802.11b, 802.11a, HomeRF, or Bluetooth. The processor 220 interfaces the WLAN Interface Manger 210 to the GGSN Interface Manager 330. The GGSN Interface Manager 330 runs whatever protocols are necessary to appear to the GGSN 105 as an SGSN. In an exemplary embodiment of the present invention, the GGSN Interface Manger 330 does all protocol conversion from the WLAN Interface Manager. In an alternative embodiment of the present invention, the Processor 220 handles the protocol conversion.

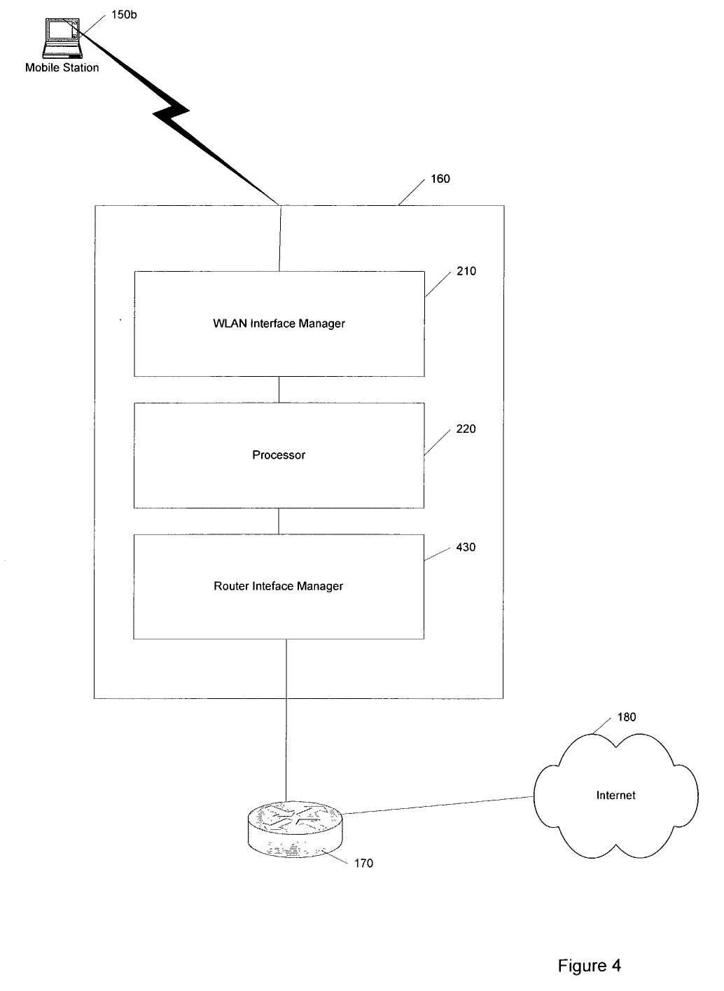

FIG. 4 illustrates one embodiment of an access point 160 according to the principles of the present invention. The access point 160 may comprise a WLAN interface manager and interface 210, a processor with accompanying memory 220, and a Router Interface Manager with interface 430. The WLAN Interface Manager 210 operates the protocols necessary to communicate with the proper WLAN standard to the mobile station 150b. This standard can be any WLAN standard, for example, 802.11b, 802.11a, HomeRF, or Bluetooth. The processor 220 interfaces the WLAN Interface Manger 210 to the Router Interface Manager 430. The Router Interface Manager 430 runs whatever protocols are necessary to appear to the GGSN 105 as an SGSN. The Router Interface Manager 430 operates in conjunction with Router 170 to tunnel via the Internet 180 to the GGSN 105. In an exemplary embodiment of the present invention, the Router Interface Manger 430 does all protocol conversion from the WLAN Interface Manager. In an alternative embodiment of the present invention, the Processor 220 handles the protocol conversion.

Alternative embodiments of the access point 160 may contain each of the three interface managers 230, 330, and 430. In such a case, process 220 will select which interface manager to communicate through. For example, the SGSN Interface Manager 230 may be established as the preferred interface, and, should this interface be lost or damaged, the processor 220 may switch to the GGSN Interface Manager 330.

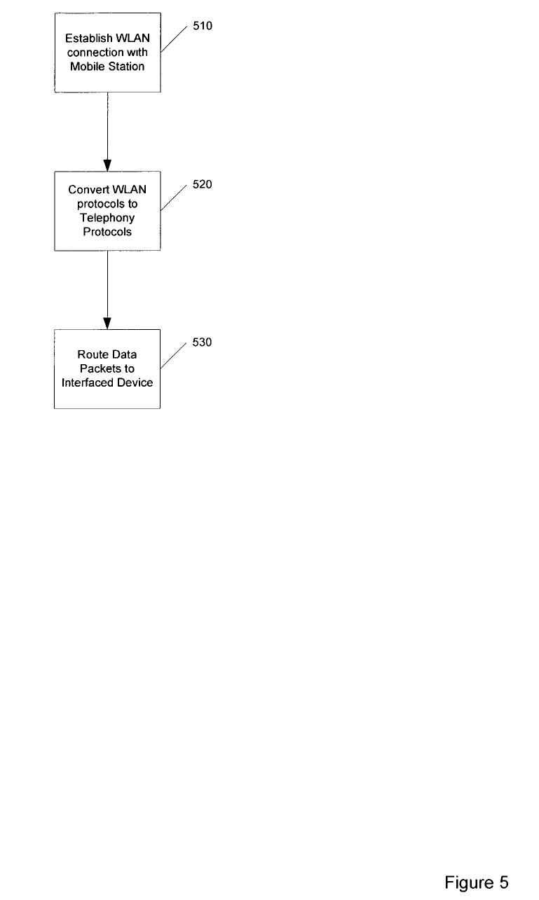

FIG. 5 illustrates a flow chart of the operation of the access point 160 according to the principles of the present invention. At stage 510, a WLAN connection is established with the mobile station. Communications is begun with the mobile station. At stage 520, the WLAN protocols are converted to the appropriate telephony protocols for the interfaced upstream device. At stage 530, the incoming data stream from the mobile station is routed to the core network of the telephony system.

Identification of an access point or mobile station in exemplary embodiments of the present invention may be different from in traditional GSM/GPRS/UMTS networks. In those networks, mobile stations are identified using the International Mobile Subscriber Identity (IMSI). In GSM/UMTS networks, the Home Location Registry maintains a database that uniquely identifies each subscriber by an IMSI and also one or more conventional phone numbers. In the case of packet data transmission over the GPRS, the mobile station is also identified by the IMSI or possibly the packet TMSI. In conventional wireless local area networks (WLAN), the mobile stations are identified by a 48 bit MAC address.

Exemplary embodiments of the present invention may identify may use standard GSM or UMTS procedures when accessing the network in GPRS/UMTS mode. To identify the mobile device when operating in WLAN mode, the device may transmit the IMSI to the GGSN which may then authenticate the user via the Home Location Registry, similar to the convention procedure. Altenatively, the mobile device, or access point, may be identified by its 48 bit MAC address and the GGSN would access a database, for example an extension of the Home Location Registry, that would correlate the IMSI with the MAC address. Likewise, if the access point is identified by a username/password token, this may be stored in the HLR extension and accessed by the GGSN for authentication.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An access point for interfacing a mobile station having a wireless local area network interface to a wireless telecommunications network, comprising:
a wireless local area network interface for receiving a packetized data stream from the interface of the mobile station; and
a processor for transferring the packetized data stream to a first mobile telephony interface, wherein
the first mobile telephony interface receives the packetized data stream and interfaces with a core network element to establish a communications link and transmit the packetized data stream to the core network element, such that the mobile station appears as an element in the mobile telephony network

2. The access point of claim 1, wherein the mobile telephony interface is operable to convert a protocol of the wireless local area network interface to a protocol of the first mobile telephony interface.

3. The access point of claim 1, wherein the processor is operable to convert a protocol of the wireless local area network interface to a protocol of the first mobile telephony interface.

4. The access point of claim 1, wherein the first mobile telephony interface appears to the core network as a base station.

5. The access point of claim 4, wherein the core network element is a serving node and the first mobile telephony interface connects to the serving node.

6. The access point of claim 1, wherein the first mobile telephony interface appears to the core network as a serving node.

7. The access point of claim 6, wherein the core network element is a gateway node and the first mobile telephony interface connects to the gateway node.

8. The access point of claim 7, wherein the first mobile telephony interface connects to the gateway node via a router and an external network.

9. The access point of claim 8, wherein the external network is the Internet.

10. The access point of claim 1 further comprising a second mobile telephony interface.

11. The access point of claim 10, wherein the processor is operable to select to communicate with either the first or the second mobile telephony interface.

12. The access point of claim 11, wherein the processor is operable to switch from the first mobile telephony interface to the second mobile telephony interface upon a failure of the first mobile telephony interface.

13. A method of establishing communication between a mobile station equipped with a wireless local area network interface and a mobile telephony network, comprising:
establishing a wireless local area network connection with the mobile station;
receiving a packetized data stream from the mobile station;
converting the packetized data stream from a wireless local area network protocol to a mobile telephony protocol; and
establishing a connection to the core network of the mobile telephony network and transferring the converted packetized data stream to the core network.
